(19) United States
(12) Patent Application Publication
(10) Pub. No.: US 2009/0135132 A1
(43) Pub. Date: May 28, 2009

(54) Electronic display system to show large size visual content on a small size display device

(76) Inventors: Yuming Huang, (US); Weihua Wang, (US); Yujian Huang, (US)

Correspondence Address: YUMING HUANG, 810 MEADOWRIDGE DRIVE, AURORA, IL, 60504, US

(21) Appl. No.: 11/944,629

(22) Filed: Nov. 25, 2007

(51) Int. Cl. G09G 5/00; G06F 3/041

(52) U.S. Cl. 345/156; 345/173

(57) ABSTRACT

A portable display system for an electronic device is invented, which consists of a portable display and a pair of eye glasses. The size of the display is small for easy carrying, for example, the display can fit in to a hand. The resolution of the display is changeable, for example, it can be lower than one hundred by one hundred for normal cell phone usage. It can be as high as thousands by thousands to show HDTV, movie, and web browsing. When the display is in its low resolution mode, naked eyes can see the display content without problem. When the display is in its high resolution mode, the pair of glasses, which enlarges the display content a few times, is needed. There may be, depending of application, multiple resolution modes between the lowest and the highest.

The display system may allow interactive input from users. For example, a user is surfing the Internet using a cell phone, via the pair of glasses. When the user wants to follow a link, the user's finger taps the link on the display. If the area touched by the finger tip contains exactly one link, the link is followed and a new web page is shown. However, since the display content is magnified by the glasses, the area touched by the finger tip may contain other links besides the link. At this time, the display magnifies the area to allow the finger tip to pin point to a unique link. What the user sees is that the area touched by the finger tip is enlarged more than other parts of the display not touched by the finger tip. If the user does not tap again for some time, for example, a few seconds, the enlargement for the area disappears. On the other hand, if the user taps again and the area touched by the finger tip contains multiple links still, the area is magnified further. Other input media apart from web links, include but not limits to, software button, menu, list, keyboard, etc.

The invention is not about a resolution changeable display, nor about a pair of magnifying glasses. The invention is about a set of compatible displays and a pair of glasses, which work together to enable people use or enjoy visual content usually based on large size display.

### 1. FIELD OF THE INVENTION

This invention relates generally to the display system of an electronic device. It solves the problem of how to deliver a large amount (and large size, for example, HDTV, web page, movie) of visual information to a small (hand held) display and allow users to see the visual information clearly.

### 2. BACKGROUND

A major problem faced by portable electronic device (mobile phone, portable computers, etc.) to deploy certain applications (web, movie, TV, HDTV), is that easy carrying requires small size device which is unable to show the visual content and allow naked eyes to see the content clearly. The visual acuity limit of human eye is the cause.

There are solutions to increase the size of the display but keep the easy carry feature: roll-able display and slide-able display. The size is increased when is display is unfolding or slide-out. Easy carrying is achieved by folding and slide-in. However, they have shortcomings compared with this invention.

### 3. DESCRIPTION OF THE INVENTION

In this invention, the size of an electronic device display is not changed but the visual acuity is boosted compatibly with the display by a pair of magnifying glasses.

A portable display system for an electronic device is invented, which consists of a portable display and a pair of eye glasses. The size of the display is small for easy carrying, for example, the display can fit in to a hand.

The resolution of the display is changeable, for example, it can be lower than one hundred by one hundred for normal cell phone usage. It can be as high as thousands by thousands to show HDTV, movie, and web browsing. When the display is in its low resolution mode, naked eyes can see the display content without problem. When the display is in its high resolution mode, the pair of glasses, which enlarges the display content a few times, is needed. There may be, depending of application, multiple resolution modes between the lowest and the highest.

The display system may allow interactive input from users. For example, a user is surfing the Internet using a cell phone, via the pair of glasses. When the user wants to follow a link, the user's finger taps the link on the display. If the area touched by the finger tip contains exactly one link, the link is followed and a new web page is shown. However, since the display content is magnified by the glasses, the area touched by the finger tip may contain other links besides the link. At this time, the display magnifies the area to allow the finger tip to pin point to a unique link. What the user sees is that the area touched by the finger tip is enlarged more than other parts of the display not touched by the finger tip. If the user does not tap again for some time, for example, a few seconds, the enlargement for the area disappears. On the other hand, if the user taps again and the area touched by the finger tip contains multiple links still, the area is magnified further. Other input media apart from web links, include but not limits to, software button, menu, list, keyboard, etc.

The invention is not about a resolution changeable display, nor about a pair of magnifying glasses. The invention is about a set of compatible displays and a pair of glasses, which work together to enable people use or enjoy visual content usually based on large size display.

What is claimed is:

1. A display system for an electronic device, comprising a display panel and a pair of eye glasses. The resolution of the display is changeable and is controlled manually or automatically by a running application, for example, high definition TV program, or showing a cell phone number. When the display is in its low resolution mode, normal naked eyes can see the display content clearly. When the display is in its high resolution mode, the pair of glasses, which enlarges the display content, is needed.

2. The device of claim 1, is a cell phone or other wireless communication equipment.

3. The device of claim 1, is a hand held computer, PDA, etc.

4. The device of claim 1, is a portable TV set.

5. The display system of the device of claim 1, allows interactive input from users. For example, a user is surfing the Internet using a cell phone, via the pair of glasses. When the user wants to follow a link, the user's finger taps the link on the display. If the area touched by the finger tip contains exactly one link, the link is followed and a new web page is shown. However, since the display content is magnified by the glasses, the area touched by the finger tip may contain other links besides the link. At this time, the display magnifies the area to allow the finger tip to pin point to a unique link. What the user sees is that the area touched by the finger tip is enlarged more than other parts of the display not touched by the finger tip. If the user does not tap again for some time, for example, a few seconds, the enlargement for the area disappears. On the other hand, if the user taps again and the area touched by the finger tip contains multiple links still, the area is magnified further. Other input media apart from web links, include but not limits to, software button, menu, list, keyboard, etc.

6. The device of claim 1, is a portable or easy carry electronic device.

7. The display system of claim 1 has, depending of application, multiple resolution modes between the lowest and the highest.

8. The device of claim 5, is a cell phone or other wireless communication equipment.

9. The device of claim 5, is a hand held computer, PDA, etc.

10. The device of claim 5, is a portable TV set.

11. A display system for an electronic device, comprising one or multiple display panels and one or multiple pairs of eye glasses. The resolution of the display panels may be different, changeable and controlled manually or automatically by a running application, for example, high definition TV program, or showing a cell phone number. When a display panel is in its low resolution mode, normal naked eyes can see the display content clearly. When the display panel is in its high resolution mode, a pair of glasses, which enlarges the display content, is needed.

12. Safety consideration of claim 1˜11. To prevent from unknowingly wearing the magnification glasses, warns the wearer, say beep sound, if the display is not in the field of the pair of glasses. There may be a warning if the user watches the display via the glasses for an extended long time.
